(19) United States
(12) Patent Application Publication
(10) Pub. No.: US 2022/0056821 A1
(43) Pub. Date: Feb. 24, 2022

(54) HYDRAULIC PRESSURE WARNING DEVICE

(71) Applicant: ISUZU MOTORS LIMITED, Tokyo (JP)

(72) Inventor: Ken SUZUKI, Fujisawa-shi, Kanagawa (JP)

(21) Appl. No.: 17/418,727

(22) PCT Filed: Dec. 25, 2019
(86) PCT No.: PCT/JP2019/050787

§ 371 Date: Jun. 25, 2021

(30) Foreign Application Priority Data
Dec. 27, 2018 (JP) 2018-244913

(51) Int. Cl. F01M 1/20; F16H 61/12

(52) U.S. Cl. CPC F01M 1/20; F16H 61/12

(57) ABSTRACT

This hydraulic pressure warning device 100 issues a hydraulic pressure warning when an anomalous hydraulic pressure drop or clogging of an oil filter 101 has been estimated to be occurring. The hydraulic pressure warning device is provided with a control device 103 that: executes control so that a first hydraulic pressure warning is issued if an anomalous hydraulic pressure drop has been estimated to be occurring; and executes control so that a second hydraulic pressure warning is issued if clogging of the oil filter 101 has been estimated to be occurring.

### TECHNICAL FIELD

The present disclosure relates to a hydraulic pressure warning device that notifies a driver of an abnormality in a lubrication system.

### BACKGROUND ART

In an automobile, an internal combustion engine and the like are lubricated with lubricating oil (for example, engine oil) in order to prevent damage to the internal combustion engine and the like. The lubricating oil is supplied to the internal combustion engine and the like through an oil filter. If the supply of the lubricating oil to the internal combustion engine and the like is delayed, since the internal combustion engine and the like may be damaged, the automobile is equipped with a hydraulic pressure warning device that notifies a driver of an abnormality in a lubrication system.

In a related-art hydraulic pressure warning device, in a case where it is estimated that an anomalous decrease in hydraulic pressure or clogging of the oil filter occurs, the only one hydraulic pressure warning lamp is turned on to inform the driver of the abnormality in the lubrication system.

### CITATION LIST

### Patent Document

Patent Literature 1: JP-UM-S63-3299-B

Patent Literature 2: JP-2001-254614-A

Patent Literature 3: JP-2000-345821-A

### SUMMARY OF THE INVENTION

### Technical Problem

However, immediately after cold start in a low temperature environment, since oil temperature is low and oil viscosity is high, it is difficult for the lubricating oil to pass through the oil filter. Even in a case where the clogging of the oil filter does not actually occur, it is estimated that the clogging of the oil filter occurs, and the only hydraulic pressure warning lamp is turned on.

On the other hand, when a predetermined time elapses after the cold start in the low temperature environment, since the oil viscosity decreases with an increase in the oil temperature, it is estimated that the lubricating oil easily passes through the oil filter and the clogging of the oil filter is eliminated, and the only hydraulic pressure warning lamp is turned off.

As described above, immediately after the cold start in the low temperature environment, the only hydraulic pressure warning lamp may be temporarily turned on even in the case where the clogging of the oil filter does not actually occur, which may cause confusion for a driver.

An object of the present disclosure is to provide a hydraulic pressure warning device that does not cause confusion for a driver.

### Solution to Problem

A hydraulic pressure warning device issues a hydraulic pressure warning in a case where it is estimated that an anomalous decrease in hydraulic pressure or clogging of an oil filter occurs. The hydraulic pressure warning device includes a control device that estimates an occurrence of an anomalous decrease in hydraulic pressure and an occurrence of clogging of the oil filter. The control device controls to issue a first hydraulic pressure warning in a case where it is estimated that an anomalous decrease in hydraulic pressure occurs, and controls to issue a second hydraulic pressure warning in a case where it is estimated that the oil filter is clogged.

It is desirable that the first hydraulic pressure warning notifies a driver of an abnormality in a lubrication system, and gives a direction that the driver should act, and that the second hydraulic pressure system notifies the driver of an abnormality in the lubrication system.

It is desirable that the control device estimates that the oil filter is clogged in a case where a bypass valve installed in a bypass line bypassing the oil filter is open, and estimates that the oil filter is not clogged in a case where the bypass valve is closed.

### Advantageous Effects of Invention

The hydraulic pressure warning device that does not cause confusion for the driver can be provided.

### BRIEF DESCRIPTION OF THE DRAWINGS

FIG. 1 is a diagram illustrating a configuration of a hydraulic pressure warning device according to an embodiment.

FIG. 2 is a diagram illustrating an operation of the hydraulic pressure warning device according to the embodiment.

FIG. 3 is a diagram illustrating an operation of the hydraulic pressure warning device according to the embodiment.

### DESCRIPTION OF EMBODIMENTS

Hereinafter, an embodiment will be described in order of the accompanying drawings.

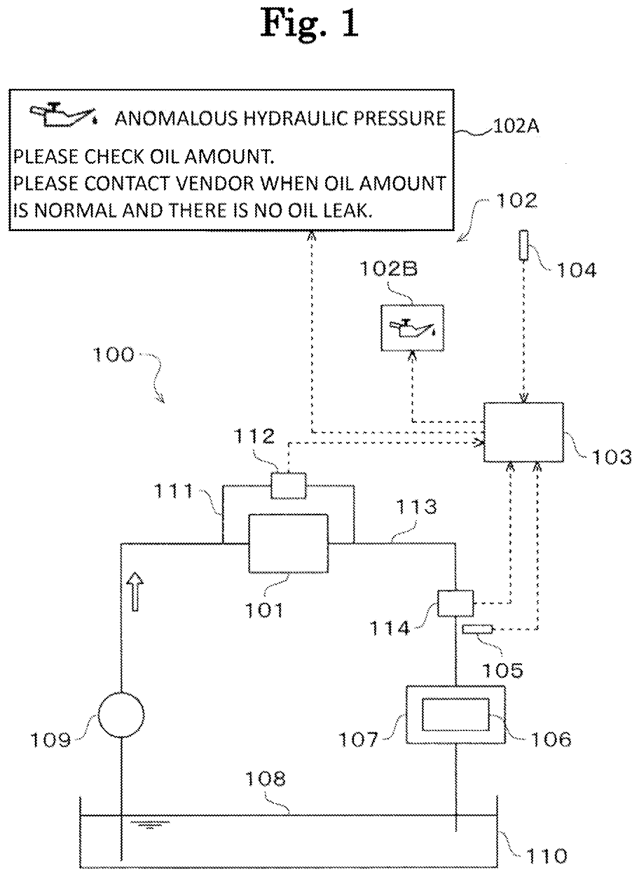

As illustrated in FIG. 1, the hydraulic pressure warning device 100 notifies a driver of an abnormality in a lubrication system, and includes a control device 103 that issues a hydraulic pressure warning in a case where it is estimated that an anomalous decrease in hydraulic pressure or clogging of an oil filter 101 occurs.

In the present embodiment, it has been described that the control device 103 issues the hydraulic pressure warning by turning on a hydraulic pressure warning lamp 102, but instead of or in addition to the visual warning using the hydraulic pressure warning lamp 102, for example, the control device 103 can issue an auditory warning using a speaker. Further, the visual warning is not limited to the warning using the hydraulic pressure warning lamp 102, and may be, for example, a warning using a monitor.

The hydraulic pressure warning lamp 102 includes a first hydraulic pressure warning lamp 102A that notifies the driver of the abnormality in the lubrication system and gives a direction that the driver should act, and a second hydraulic pressure warning lamp 102B that notifies the driver of the abnormality in the lubrication system.

The first hydraulic pressure warning lamp 102A is constituted by characters and patterns displayed on a multi-information display, and the second hydraulic pressure warning lamp 102B is constituted by a lamp installed on an instrument panel. The first hydraulic pressure warning lamp 102A and the second hydraulic pressure warning lamp 102B are in an OFF state in an initial state.

Giving the direction that the driver should act means prompting the driver to inspect the automobile. Therefore, the first hydraulic pressure warning lamp 102A not only notifies the driver of the abnormality in the lubrication system by being turned on, but also gives the driver a compulsive feeling in order to cause the driver to take appropriate action to eliminate the abnormality in the lubrication system.

On the other hand, notifying the driver of the abnormality in the lubrication system means displaying the lamp. Therefore, the second hydraulic pressure warning lamp 102B only notifies the driver of the abnormality in the lubrication system by being turned on, and does not restrict the driver's action or give the driver a compulsive feeling.

The control device 103 may be constituted by an electronic control unit (ECU), or may be constituted by an electric circuit or an electronic circuit. The control device 103 can determine whether the condition corresponds to a cold start in a low temperature environment based on an outside air temperature and an oil temperature detected by an outside air temperature sensor 104 and an oil temperature sensor 105.

The oil filter 101 filters lubricating oil 108 supplied to a lubrication target 107 represented by an internal combustion engine 106. The lubricating oil 108 is circulated in order through an oil pan 110, the oil filter 101, and the lubrication target 107 using an oil pump 109, and lubricates the lubrication target 107.

In a case where a hydraulic pressure in the oil filter 101 is equal to or higher than an upper limit hydraulic pressure, a bypass valve 112 installed in a bypass line 111 that bypasses the oil filter 101 is opened, and the lubricating oil 108 is supplied to the lubrication target 107 without passing through the oil filter 101. That is, even in a case where the oil filter 101 is clogged, the lubrication of the lubrication target 107 can be continued.

The bypass valve 112 is opened in the case where the hydraulic pressure in the oil filter 101 is equal to or higher than the upper limit hydraulic pressure, and is closed in a case where the hydraulic pressure in the oil filter 101 is lower than the upper limit hydraulic pressure. That is, by mechanically or electrically detecting the opening and closing of the bypass valve 112, it is possible to estimate whether the oil filter 101 is clogged.

Specifically, the control device 103 can estimate that the oil filter 101 is clogged in a case where the bypass valve 112 is open, and can estimate that the oil filter 101 is not clogged in a case where the bypass valve 112 is closed.

However, the control device 103 cannot determine whether the bypass valve 112 is open due to the clogging of the oil filter 101 or due to low oil temperature and high oil viscosity.

A supply line 113 that connects the oil filter 101 and the lubrication target 107 is provided with a hydraulic pressure switch 114 that is switched on or off depending on whether the hydraulic pressure in the supply line 113 is lower than a lower limit hydraulic pressure. That is, by mechanically or electrically detecting the on/off of the hydraulic pressure switch 114, it is possible to estimate whether an anomalous decrease in the hydraulic pressure occurs. Incidentally, the oil temperature sensor 105 is also installed in the supply line 113.

For example, the control device 103 can estimate that the anomalous decrease in the hydraulic pressure occurs in a case where the hydraulic pressure switch 114 is on, and can estimate that the anomalous decrease in the hydraulic pressure does not occur in a case where the hydraulic pressure switch 114 is off.

In a related-art hydraulic pressure warning device, since the only one hydraulic pressure warning lamp is turned on in a case where it is estimated that the oil filter is clogged, immediately after the cold start in the low temperature environment, the only hydraulic pressure warning lamp may be temporarily turned on even in a case where the oil filter is not actually clogged, which may cause confusion for the driver.

On the other hand, in the hydraulic pressure warning device 100, the control device 103 issues a first hydraulic pressure warning (turning on the first hydraulic pressure warning lamp 102A) in the case where it is estimated that the anomalous decrease in the hydraulic pressure occurs, and issues a second hydraulic pressure warning (turning on the second hydraulic pressure warning lamp 102B) in the case where it is estimated that the oil filter 101 is clogged.

In the present embodiment, it has been described that the control device 103 issues the visual warning using the hydraulic pressure warning lamp 102 in both the first hydraulic pressure warning and the second hydraulic pressure warning, but it is also possible to issue different warnings in the first hydraulic pressure warning and the second hydraulic pressure warning. For example, in the first hydraulic pressure warning, the visual warning using the hydraulic pressure warning lamp 102 can be issued, and in the second hydraulic pressure warning, the auditory warning using the speaker can be issued.

Therefore, in the hydraulic pressure warning device 100, by confirming which one of the first hydraulic pressure warning lamp 102A and the second hydraulic pressure warning lamp 102B is turned on, it is possible to appropriately determine whether the abnormality in the lubrication system is urgent.

For example, in a case where only the second hydraulic pressure warning lamp 102B is turned on after the internal combustion engine 106 is started and the second hydraulic pressure warning lamp 102B is turned off after a predetermined time elapses, it can be considered that temporary clogging of the oil filter 101 due to the cold start in the low temperature environment has occurred, and thus there is no risk of causing confusion for the driver.

On the other hand, in a case where only the first hydraulic pressure warning lamp 102A is turned on or in a case where both the first hydraulic pressure warning lamp 102A and the second hydraulic pressure warning lamp 102B are turned on, it can be considered that the abnormality in the lubrication system is urgent, so that the driver can take appropriate action.

Next, an operation of the hydraulic pressure warning device 100 will be described in detail.

[Control Relating to Anomalous Decrease in Hydraulic Pressure]

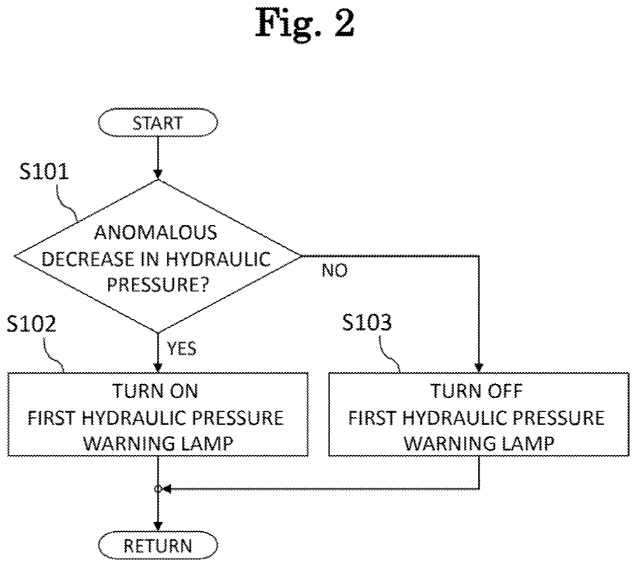

As illustrated in FIG. 2, in an initial step S101, the control device 103 estimates whether the anomalous decrease in the hydraulic pressure occurs based on the on/off of the hydraulic pressure switch 114.

In the case where it is estimated that the anomalous decrease in the hydraulic pressure occurs, the processing proceeds to step S102, and if the first hydraulic pressure warning lamp 102A is turned off, the control device 103 turns on the first hydraulic pressure warning lamp 102A, and the processing returns to step S101.

In the case where the anomalous decrease in the hydraulic pressure occurs, it is assumed that the supply of the lubricating oil 108 to the lubrication target 107 is delayed due to oil leakage and the like, and the lubrication target 107 may be damaged, so that it is desirable to inspect the automobile immediately.

In the hydraulic pressure warning device 100, in the case where the anomalous decrease in the hydraulic pressure occurs, the first hydraulic pressure warning lamp 102A is turned on, and it is possible to notify the driver of the abnormality in the lubrication system and to give a direction that the driver should act, so that the driver can grasp the abnormality in the lubrication system that may lead to a serious failure at an early stage.

In a case where it is estimated that the anomalous decrease in the hydraulic pressure does not occur, the processing proceeds to step S103, and if the first hydraulic pressure warning lamp 102A is turned on, the control device 103 turns off the first hydraulic pressure warning lamp 102A, and the processing returns to step S101.

[Control Relating to Clogging of Oil Filter]

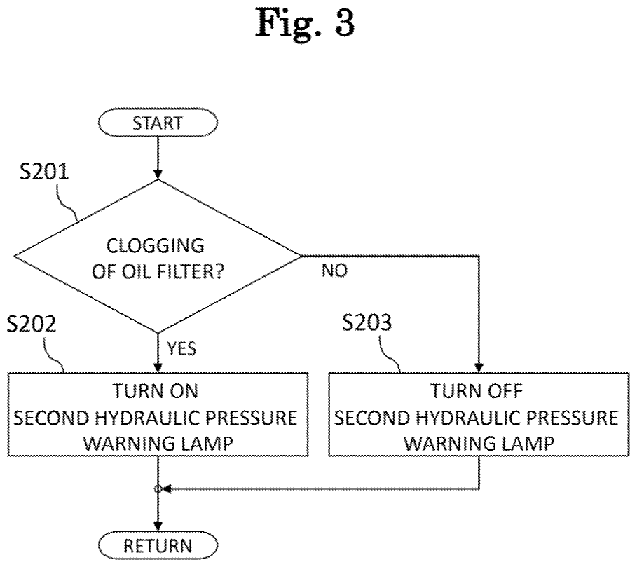

As illustrated in FIG. 3, in the initial step S201, the control device 103 estimates whether the oil filter 101 is clogged based on the open/closed state of the bypass valve 112.

In the case where it is estimated that the oil filter 101 is clogged, the processing proceeds to step S202, and if the second hydraulic pressure warning lamp 102B is turned off, the control device 103 turns on the second hydraulic pressure warning lamp 102B, and the processing returns to step S101.

In a case where it is estimated that the oil filter 101 is not clogged, the processing proceeds to step S203, and if the second hydraulic pressure warning lamp 102B is turned on, the control device 103 turns off the second hydraulic pressure warning lamp 102B, and the processing returns to step S101.

As described above, in the hydraulic pressure warning device 100, the first hydraulic pressure warning lamp 102A is turned on in the case where it is estimated that the anomalous decrease in the hydraulic pressure occurs, and the second hydraulic pressure warning lamp 102B is turned on in the case where it is estimated that the oil filter 101 is clogged, so that there is no risk of causing confusion for the driver.

The present application is based on Japanese Patent Application (No. 2018-244913) filed on Dec. 27, 2018, contents of which are incorporated herein as reference.

The hydraulic pressure warning device of the present disclosure is useful in that there is no risk of causing confusion for the driver.

### LIST OF REFERENCE NUMERALS

100 hydraulic pressure warning device
101 oil filter
102 hydraulic pressure warning lamp
103 control device
104 outside air temperature sensor
105 oil temperature sensor
106 internal combustion engine
107 lubrication target
108 lubricating oil
109 oil pump
110 oil pan
111 bypass line
112 bypass valve
113 supply line
114 hydraulic pressure switch

1. A hydraulic pressure warning device that issues a hydraulic pressure warning in a case where it is estimated that an anomalous decrease in hydraulic pressure or clogging of an oil filter occurs, the hydraulic pressure warning device comprising:
a control device that estimates an occurrence of an anomalous decrease in hydraulic pressure and an occurrence of clogging of the oil filter,
wherein the control device controls to issue a first hydraulic pressure warning in a case where it is estimated that an anomalous decrease in hydraulic pressure occurs, and controls to issue a second hydraulic pressure warning in a case where it is estimated that the oil filter is clogged.

2. The hydraulic pressure warning device according to claim 1,
wherein the first hydraulic pressure warning notifies a driver of an abnormality in a lubrication system, and gives a direction that the driver should act, and
the second hydraulic pressure system notifies the driver of an abnormality in the lubrication system.

3. The hydraulic pressure warning device according to claim 1,
wherein the control device estimates that the oil filter is clogged in a case where a bypass valve installed in a bypass line bypassing the oil filter is open, and estimates that the oil filter is not clogged in a case where the bypass valve is closed.

4. The hydraulic pressure warning device according to claim 2,
wherein the control device estimates that the oil filter is clogged in a case where a bypass valve installed in a bypass line bypassing the oil filter is open, and estimates that the oil filter is not clogged in a case where the bypass valve is closed.
